(19) United States
(12) Patent Application Publication
(10) Pub. No.: US 2012/0062710 A1
(43) Pub. Date: Mar. 15, 2012

(54) 3D DISPLAY APPARATUS AND METHODS WITH VIDEO PROCESSING AND FRAME PACKING BASED ON DISPLAY FORMAT INFORMATION

(75) Inventors: Dong Han Lee, Seongnam-si (KR); Jae Sop Kong, Gwacheon-si (KR)

(73) Assignee: Samsung Electronics Co., Ltd.

(21) Appl. No.: 13/232,435

(22) Filed: Sep. 14, 2011

(30) Foreign Application Priority Data
Sep. 14, 2010 (KR) 10-2010-0089741

(51) Int. Cl. H04N 13/04

(52) U.S. Cl. 348/51; 348/E13.075

(57) ABSTRACT

A 3D display engine includes a timing generator circuit configured to receive format information from a 3D display and to responsively generate display timing information, a video image data processor circuit configured to receive and process left and right video image data, a 3D format generator circuit configured to frame-pack the processed left and right video image data and a controller circuit configured to control the video image data processor circuit and the 3D format generator circuit responsive to the display timing information.

### CROSS-REFERENCE TO RELATED APPLICATIONS

This application claims priority under 35 U.S.C. §119(a) from Korean Patent Application No. 10-2010-0089741 filed on Sep. 14, 2010, the disclosure of which is hereby incorporated by reference in its entirety.

### BACKGROUND

The inventive subject matter relates to display apparatus and methods and, more particularly, to 3D display apparatus and methods.

Unlike a two-dimensional (2D) display, a 3D display is required to display a left video source and a right video source in a single frame in order to display a 3D image.

### SUMMARY

Some embodiments of the inventive subject matter provide a three-dimensional (3D) display engine including a timing generator circuit configured to generate a plurality of timing control signals according to a format of a 3D display and a controller circuit configured to generate first, second and third control signals based on the plurality of timing control signals. The display engine further includes a first processor circuit configured to process left video image data in response to the first control signal, a second processor circuit configured to process right video image data in response to the second control signal and a 3D format generator circuit configured to frame-pack the processed left and right video image data in the format of the 3D display in response to the third control signal. The display engine may further include a frame buffer circuit configured to store the left video image data and the right video image data.

The first processor circuit may include an image enhancer circuit configured to process the left image video data to reduce noise and/or blurring, a scaler circuit configured to convert the left video image data from a first resolution to a second resolution, a color space converter circuit configured to convert the left video image data from a first color space to a second color space and a layout overlay mixer circuit configured to generate overlaid left video image data. The second processor circuit may include an image enhancer circuit configured to process the right image video data to reduce noise and/or blurring, a scaler circuit configured to convert the right video image data from a first resolution to a second resolution, a color space converter circuit configured to convert the right video image data from a first color space to a second color space and a layout overlay mixer circuit configured to generate overlaid right video image data.

The 3D format generator circuit may include a selector circuit configured to select the processed left or right video image data and a buffer circuit configured to store the selected processed left or right video image data. In some embodiments, the 3D format generator circuit may include a selector circuit configured to selectively output the processed left and right video image data.

The timing generator circuit may be configured to generate the plurality of timing control signals responsive to information transmitted by the 3D display. The information transmitted by the 3D display may identify a resolution, a line frequency and/or a pixel frequency of the 3D display. The timing generator circuit may be configured to generate a vertical synchronization signal and/or a horizontal synchronization signal, and the controller circuit may be configured to generate the first, second and third control signals responsive to the vertical synchronization signal and/or the horizontal synchronization signal.

Some embodiments provide methods including receiving format information from a 3D display and generating first, second and third control signals responsive to the received format information. Left video image data is processed in response to the first control signal. Right video image data is processed in response to the second control signal. The processed left video image data and the processed right video image data are frame packed in a format of the 3D display in response to the third control signal. Generating the first, second and third control signals may include generating a plurality of timing control signals responsive to received format information and generating the first, second and third control signals based on the plurality of timing control signals.

Processing left video image data may include processing the left video image data to reduce noise and/or blurring, converting the left video image data from a first resolution to a second resolution, converting the left video image data from a first color space to a second color space and mixing on the left video image data to generate an overlaid left video image stream. Processing the right video image data may include processing the right video image data to reduce noise and/or blurring, converting the right video image data from a first resolution to a second resolution, converting the right video image data from a first color space to a second color space and mixing on the right video image data to generate an overlaid right video image stream.

Frame packing the processed left video image data and the processed right video image data may include selecting the processed left and right video image data and buffer circuiting the selected processed left and right video image data. Frame packing the processed left video image data and the processed right video image data may include selectively outputting the processed left and right video image data.

Further embodiments provide a 3D display engine including a timing generator circuit configured to receive format information from a 3D display and to responsively generate display timing information, a video image data processor circuit configured to receive and process left and right video image data, a 3D format generator circuit configured to frame-pack the processed left and right video image data and a controller circuit configured to control the video image data processor circuit and the 3D format generator circuit responsive to the display timing information. The video image data processor circuit may include a first processor circuit configured to process left video image data in response to a first control signal and a second processor circuit configured to process right video image data in response to a second control signal. The 3D format generator circuit may be configured to frame-pack the processed left and right video image data in response to a third control signal. The controller circuit may be configured to generate the first, second and third control signals. The display timing information may pertain to a vertical synchronization, a horizontal synchronization, a line frequency and/or a pixel frequency.

### BRIEF DESCRIPTION OF THE DRAWINGS

The above and other features and advantages of the inventive subject matter will become more apparent by describing in detail exemplary embodiments thereof with reference to the attached drawings in which:

FIG. 1 is a schematic block diagram of a three-dimensional (3D) display system including a 3D display engine according to some embodiments of the inventive subject matter;

FIG. 2 is a schematic block diagram of the 3D display engine illustrated in FIG. 1;

FIG. 3 shows the format of 3D display according to some embodiments of the inventive subject matter;

FIG. 4 shows a 3D display format according to other embodiments of the inventive subject matter;

FIG. 5 shows a 3D display format according to further embodiments of the inventive subject matter;

FIG. 6 shows a 3D display format according to other embodiments of the inventive subject matter;

FIG. 7 shows a 3D display format according to yet other embodiments of the inventive subject matter;

FIG. 8 shows a 3D display format according to still other embodiments of the inventive subject matter;

FIG. 9 is a detailed block diagram of a first post processor circuit and a second post processor circuit illustrated in FIG. 2;

FIG. 10 is a block diagram of a 3D format generator circuit illustrated in FIG. 2 according to some embodiments of the inventive subject matter;

FIG. 11 is a block diagram of the 3D format generator circuit illustrated in FIG. 2 according to other embodiments of the inventive subject matter;

FIG. 12 is a flowchart of a method of operating a 3D display engine according to some embodiments of the inventive subject matter; and

FIG. 13 is a schematic block diagram of a 3D display system including a 3D display engine according to other embodiments of the inventive subject matter.

### DETAILED DESCRIPTION OF THE EMBODIMENTS

The inventive subject matter now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity. Like numbers refer to like elements throughout.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. As used herein, the term “and/or” includes any and all combinations of one or more of the associated listed items and may be abbreviated as “/”.

It will be understood that, although the terms first, second, etc. may be used herein to describe various elements, these elements should not be limited by these terms. These terms are only used to distinguish one element from another. For example, a first signal could be termed a second signal, and, similarly, a second signal could be termed a first signal without departing from the teachings of the disclosure.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and/or the present application, and will not be interpreted in an idealized or overly formal sense unless expressly so defined herein.

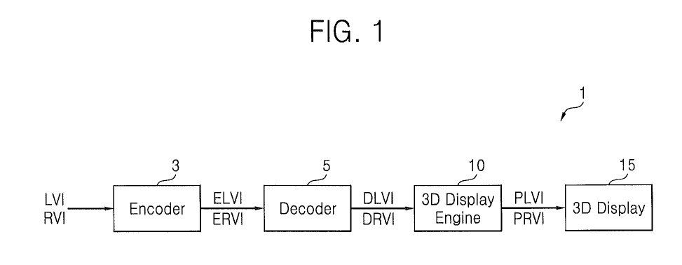

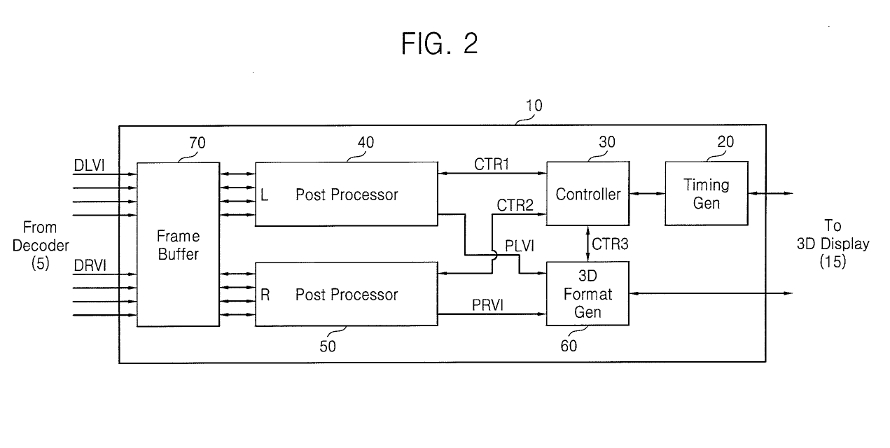

FIG. 1 is a schematic block diagram of a three-dimensional (3D) display system 1 including a 3D display engine 10 according to some embodiments of the inventive subject matter. FIG. 2 is a schematic block diagram of the 3D display engine 10 illustrated in FIG. 1.

Referring to FIG. 1, the 3D display system 1 includes an encoder 3, a decoder 5, the 3D display engine 10, and a 3D display 15. The encoder 3 receives and encodes a left video image LVI and a right video image RVI so that a 3D image is displayed on the 3D display 15. The encoding may be performed according to a Moving Picture Experts Group (MPEG)-4 standard, an MPEG-7 standard, or an MPEG-21 standard. The left video image LVI may be acquired by a first 3D camera and the right video image RVI may be acquired by a second 3D camera.

The 3D display 15 is a device for displaying 3D images. The 3D display 15 may be a flat panel display using a light emitting diode (LED), an organic LED (OLED), or an active matrix OLED (AMOLED).

The decoder 5 receives an encoded left video image ELVI and an encoded right video image ERVI from the encoder 3 through wired or wireless communication and decodes the encoded left video image ELVI and the encoded right video image ERVI. The 3D display engine 10 receives a decoded left video image DLVI and a decoded right video image DRVI from the decoder 5, post-processes the decoded left and right video images DLVI and DRVI, and outputs a post-processed left video image PLVI and a post-processed right video image PRVI according to the format of the 3D display 15.

The 3D display 15 may display a 3D video image in one of a variety of 3D display formats. The 3D display 15 may perform frame packing of the post-processed left video image PLVI and the post-processed right video image PRVI according to the format of the 3D display 15 and displays a single 3D video image. “Frame packing” is an operation of packing the post-processed left video image PLVI and the post-processed right video image PRVI into a single frame.

Referring to FIGS. 1 and 2, the 3D display engine 10 includes a timing generator circuit 20, a controller circuit 30, a first post processor circuit 40, a second post processor circuit 50, and a 3D format generator circuit 60.

The timing generator circuit 20 analyzes the format of the 3D display 15 and generates a plurality of timing control signals based on this analysis. The plurality of timing control signals may include, for example, a horizontal synchronization signal and a vertical synchronization signal. The timing generator circuit 20 transmits timing information of each of the plurality of timing control signals to the controller circuit 30 in response to a control signal output from the controller circuit 30. The timing information may include at least one among the start (or start time point) and the end (or end time point) of a horizontal synchronization signal, the start (or start time point) and the end (or end time point) of a vertical synchronization signal, a line frequency, and a pixel frequency, which are used to display a video image in the format of the 3D display 15. According to some embodiments, the timing generator circuit 20 may generate the plurality of timing control signal according to resolution, the line frequency, or the pixel frequency.

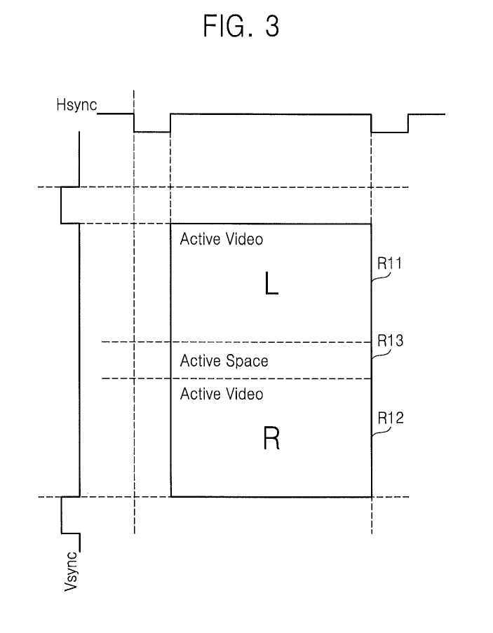

FIGS. 3 through 8 show various 3D display formats according to different embodiments of the inventive subject matter.

The 3D display format illustrated in FIG. 3 is used to display a video frame generated through progressive 3D display frame packing on the 3D display 15. Referring to FIGS. 1 through 3, the post-processed left video image PLVI and the post-processed right video image PRVI according to the progressive 3D display frame packing are packed into a single video frame.

The 3D display 15 sequentially displays the post-processed left video image PLVI and the post-processed right video image PRVI according to the progressive 3D display frame packing in two active video regions R11 and R12, respectively, in response to a vertical synchronization signal Vsync and a horizontal synchronization signal Hsync. In other words, the post-processed left video image PLVI is displayed in the left active video region R11 and the post-processed right video image PRVI is displayed in the right active video region R12.

When a packed progressive 3D display frame (hereinafter, referred to as a progressive 3D display frame) is compared with a progressive two-dimensional (2D) display frame, the number of horizontal pixels in the progressive 3D display frame is the same as that in the progressive 2D display frame. However, the number of vertical lines in the progressive 3D display frame is double the number of vertical lines in the progressive 2D display frame. The clock frequency of the progressive 3D display frame is double the clock frequency of the progressive 2D display frame.

In addition, the progressive 3D display frame includes an active space R13 between the two active video regions R11 and R12. The post-processed left video image PLVI or the post-processed right video image PRVI may be transmitted to the 3D display 15 for the active space R13, but the 3D display 15 does not display the transmitted post-processed left or right video image PLVI or PRVI in the active space R13. Accordingly, a user perceives the post-processed left video image PLVI and the post-processed right video image PRVI in a single video frame as a 3D image.

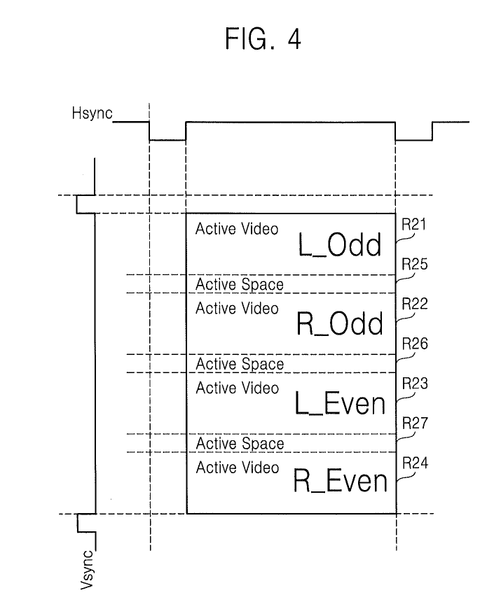

The 3D display format illustrated in FIG. 4 is used to display a video frame generated through interlaced 3D display frame packing on the 3D display 15. Referring to FIGS. 1, 2, and 4, in a packed interlaced 3D display frame (hereinafter, referred to as an interlaced 3D display frame), the post-processed left video image PLVI is divided into a group of odd lines and a group of even lines and the post-processed right video image PRVI is divided into a group of odd lines and a group of even lines. The group of odd lines of the post-processed left video image PLVI, the group of odd lines of the post-processed right video image PRVI, the group of even lines of the post-processed left video image PLVI, and the group of even lines of the post-processed right video image PRVI are sequentially displayed in regions R21, R22, R23, and R24, respectively, in response to the vertical synchronization signal Vsync and the horizontal synchronization signal Hsync. In other words, the group of odd lines of the post-processed left video image PLVI, the group of odd lines of the post-processed right video image PRVI, the group of even lines of the post-processed left video image PLVI, and the group of even lines of the post-processed right video image PRVI are sequentially packed into a single video frame using the interlaced 3D display frame packing.

When the interlaced 3D display frame is compared with an interlaced 2D display frame, the number of horizontal pixels in the interlaced 3D display frame is the same as the number of horizontal pixels in the interlaced 2D display frame. However, the number of vertical lines in the interlaced 3D display frame is double the number of vertical lines in the interlaced 2D display frame. The clock frequency of the interlaced 3D display frame is double the clock frequency of the interlaced 2D display frame. In addition, the interlaced 3D display frame includes a first active space R25 between the group of odd lines of the post-processed left video image PLVI and the group of odd lines of the post-processed right video image PRVI, a second active space R26 between the group of odd lines of the post-processed right video image PRVI and the group of even lines of the post-processed left video image PLVI, and a third active space R27 between the group of even lines of the post-processed left video image PLVI and the group of even lines of the post-processed right video image PRVI.

The post-processed left video image PLVI or the post-processed right video image PRVI may be transmitted to the 3D display 15 for the active spaces R25, R26, and R27, but the 3D display 15 does not display the transmitted odd and even lines of the post-processed left video image PLVI and the transmitted odd and even lines of the post-processed right video image PRVI in the active spaces R25.

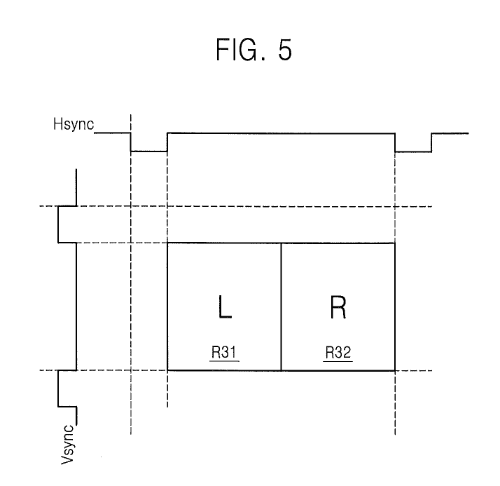

The 3D display format illustrated in FIG. 5 is used to display a video frame generated through progressive 3D display side-by-side packing on the 3D display 15. Referring to FIGS. 1, 2, and 5, a packed progressive 3D display side-by-side frame includes the post-processed left video image PLVI and the post-processed right video image PRVI to be displayed in a first region R31 and a second region R32, respectively, in response to the vertical synchronization signal Vsync and the horizontal synchronization signal Hsync.

When the progressive 3D display side-by-side frame is compared with a progressive 2D display frame, the number of horizontal pixels in the side-by-side frame is the same as the number of horizontal pixels in the 2D display frame. The number of vertical lines in the side-by-side frame is the same as the number of vertical lines in the 2D display frame. The clock frequency of the side-by-side frame is the same as the clock frequency of the 2D display frame. In other words, the horizontal resolution of each of the post-processed left video image PLVI and the post-processed right video image PRVI which will be displayed in a single frame on the 3D display 15 is half of the horizontal resolution of the single frame. For instance, when the single frame has a resolution of 1920×1080, each of the left and right video images has a resolution of 960×1080.

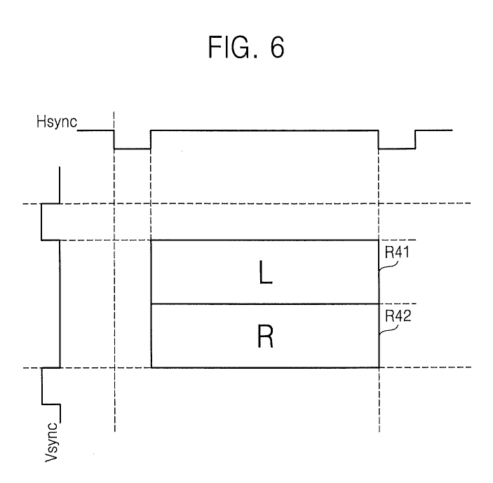

The 3D display format illustrated in FIG. 6 is used to display a video frame generated through progressive 3D display top-bottom packing on the 3D display 15. Referring to FIGS. 1, 2, and 6, a packed progressive 3D display top-bottom frame includes the post-processed left video image PLVI and the post-processed right video image PRVI to be displayed in a first region R41 and a second region R42, respectively, in response to the vertical synchronization signal Vsync and the horizontal synchronization signal Hsync.

When the progressive 3D display top-bottom frame is compared with a progressive 2D display frame, the number of horizontal pixels in the 3D display top-bottom frame is the same as the number of horizontal pixels in the 2D display frame. The number of vertical lines in the 3D display top-bottom frame is the same as the number of vertical lines in the 2D display frame. The clock frequency of the 3D display top-bottom frame is the same as the clock frequency of the 2D display frame. In other words, the vertical resolution of each of the post-processed left video image PLVI and the post-processed right video image PRVI which will be displayed in a single frame on the 3D display 15 is half of the vertical resolution of the single frame. For instance, when the single frame has a resolution of 1920×1080, each of the left and right video images has a resolution of 1920×540.

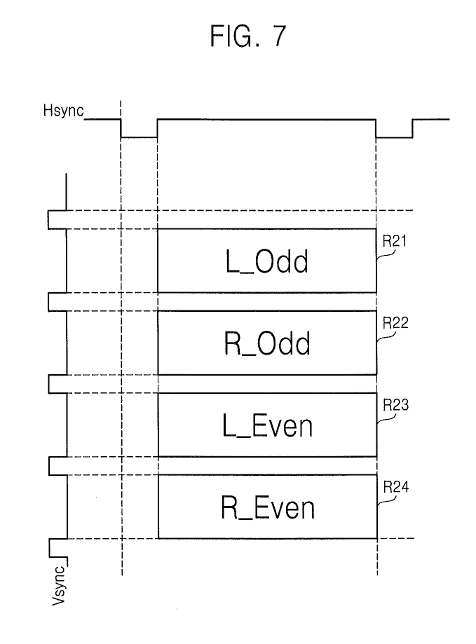

The 3D display format illustrated in FIG. 7 is used to display a video frame generated through interlaced 3D display field alternative packing on the 3D display 15. Referring to FIG. 7, a packed interlaced 3D display field alternative frame is similar to the interlaced 3D display frame illustrated in FIG. 4, but the interlaced 3D display field alternative frame does not include an active space compared with FIG. 4.

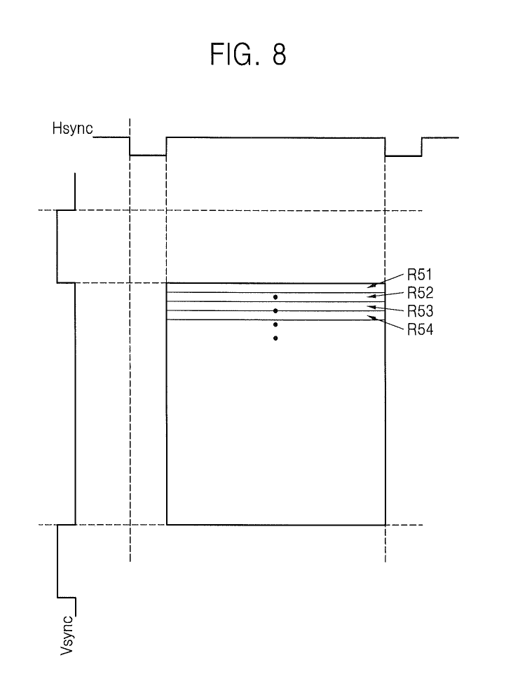

The 3D display format illustrated in FIG. 8 is used to display a video frame generated through progressive 3D display line alternative packing on the 3D display 15. Referring to FIG. 8, the post-processed left video image PLVI and the post-processed right video image PRVI are divided into lines in a progressive 3D display line alternative frame. A first line post-processed left video image, a first line post-processed right video image, a second line post-processed left video image, and a second line post-processed right video image are sequentially displayed in regions R51, R52, R53, and R54, respectively, in response to the vertical synchronization signal Vsync and the horizontal synchronization signal Hsync.

Referring back to FIG. 2, the controller circuit 30 generates a plurality of control signals CTR1, CTR2, and CTR3 based on the timing information of each of the plurality of timing control signals. The timing information includes at least one among the start and the end of a horizontal synchronization signal, the start and the end of a vertical synchronization signal, a line frequency, and a clock frequency, which are used to display a video image in the format of the 3D display 15. The first control signal CTR1 is for controlling the operation of the first post processor circuit 40. The second control signal CTR2 is for controlling the operation of the second post processor circuit 50. The third control signal CTR3 is for controlling the operation of the 3D format generator circuit 60.

The first post processor circuit 40 post-processes the decoded left video image DLVI in response to the first control signal CTR1 among the plurality of the control signals CTR1, CTR2, and CTR3. The second post processor circuit 50 post-processes the decoded right video image DRVI in response to the second control signal CTR2 among the plurality of the control signals CTR1, CTR2, and CTR3.

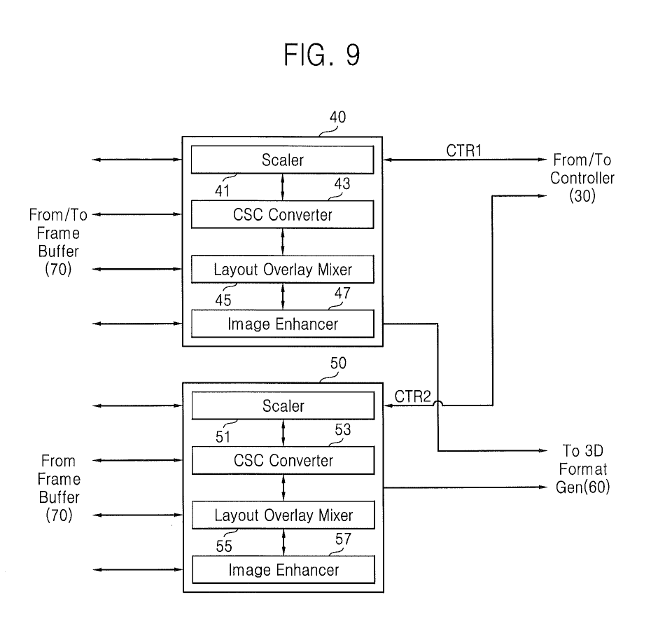

FIG. 9 is a detailed block diagram of the first post processor circuit 40 and the second post processor circuit 50 illustrated in FIG. 2. Referring to FIGS. 2 and 9, the first post processor circuit 40 includes a first scaler circuit 41, a first color space converter (CSC) circuit 43, a first layout overlay mixer circuit 45, and a first image enhancer circuit 47.

The first scaler circuit 41 converts the decoded left video image DLVI having a first resolution into a left video image having a second resolution in response to the first control signal CTR1. For example, the first resolution may be 640×480 and the second resolution may be 1280×720 or 1920×1080. Since the resolution of the 3D display 15 varies with the types of the 3D display 15, the first scaler circuit 41 converts the decoded left video image DLVI having the first resolution (e.g., 640×480) into a left video image having the second resolution (e.g., 1920×1080), so that the post-processed left video image PLVI can be displayed on the 3D display 15.

The first CSC circuit 43 converts the decoded left video image DLVI having a first color space into a left video image having a second color space in response to the first control signal CTR1. The first color space may be YCbCr or YIQ, which is used for digital encoding and enables that efficient use of bandwidth. In YCbCr, “Y” is luma and represents the luminance of an image, “Cb” is blue chroma and represents the intensity of blue color, and “Cr” is red chroma and represents the intensity of red color. In YIQ, “Y” is luma and represents the luminance of an image, “I” is blue chroma and represents the intensity of blue color, and “Q” is red chroma and represents the intensity of red color.

The second color space may be RGB or CMYK. In RGB, “R” is red and represents the intensity of red color, “G” is green and represents the intensity of green color, and “B” is blue and represents the intensity of blue color. In CMYK, “C” is cyan and represents the intensity of cyan color, “M” is magenta and represents the intensity of magenta color, “Y” is yellow and represents the intensity of yellow color, and “K” is black and represents the intensity of black color.

The first layout overlay mixer circuit 45 mixes non-overlaid left video images DLVI in response to the first control signal CTR1 to generate an overlayed left video image. The first image enhancer circuit 47 eliminates noise or blurring from the decoded left video image DLVI in response to the first control signal CTR1. According to some embodiments, the first image enhancer circuit 47 may enhance the contrast.

The first scaler circuit 41, the first CSC circuit 43, the first layout overlay mixer circuit 45, and the first image enhancer circuit 47 in the first post processor circuit 40 may sequentially or simultaneously perform the scaling, the converting, the mixing, and the enhancing.

The second post processor circuit 50 includes a second scaler circuit 51, a second CSC circuit 53, a second layout overlay mixer circuit 55, and a second image enhancer circuit 57.

The second scaler circuit 51 converts the decoded right video image DRVI having the first resolution into a right video image having the second resolution in response to the second control signal CTR2.

The second CSC circuit 53 converts the decoded right video image DRVI having the first color space into a right video image having the second color space in response to the second control signal CTR2.

The second layout overlay mixer circuit 55 mixes non-overlaid right video images DRVI in response to the second control signal CTR2 to generate an overlayed right video image. The second image enhancer circuit 57 eliminates noise or blurring from the decoded right video image DRVI in response to the second control signal CTR2.

Similarly to the first post processor circuit 40, the second scaler circuit 51, the second CSC circuit 53, the second layout overlay mixer circuit 55, and the second image enhancer circuit 57 in the second post processor circuit 50 may sequentially or simultaneously perform the scaling, the converting, the mixing, and the enhancing.

The 3D format generator circuit 60 formats the post-processed left video image PLVI and the post-processed right video image PRVI in response to the third control signals CTR3 so that the 3D display 15 displays the post-processed left video image PLVI and the post-processed right video image PRVI in a single video image through frame packing. In other words, the 3D format generator circuit 60 outputs the post-processed left video image PLVI and the post-processed right video image PRVI to the 3D display 15 according to the format of the 3D display 15.

For instance, when the format of the 3D display 15 is the progressive 3D display frame packing, the 3D format generator circuit 60 outputs the post-processed left video image PLVI and the post-processed right video image PRVI to the 3D display 15 so that the post-processed left video image PLVI is displayed at the top of the single frame and the post-processed right video image PRVI is displayed at the bottom of the single frame.

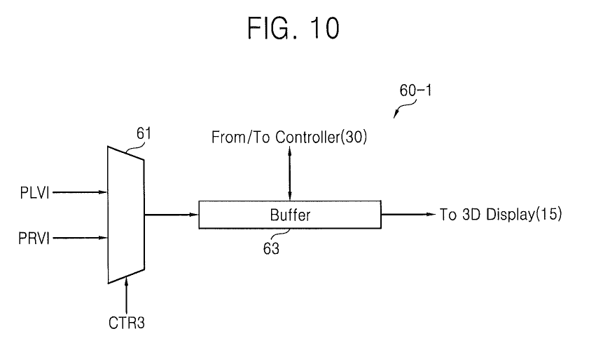

FIG. 10 is a block diagram of the 3D format generator circuit 60 illustrated in FIG. 2 according to some embodiments of the inventive subject matter. Referring to FIGS. 2 and 10, a 3D format generator circuit 60-1 includes a selector circuit 61 and a buffer circuit 63. The selector circuit 61 selectively outputs either the post-processed left video image PLVI or the post-processed right video image PRVI in response to the third control signal CTR3. The selector circuit 61 may be implemented by a multiplexer.

The buffer circuit 63 buffer circuits and outputs the post-processed left video image PLVI or the post-processed right video image PRVI output from the selector circuit 61 in response to the third control signal CTR3. The buffer circuit 63 may be implemented by a line buffer circuit. Alternatively, the buffer circuit 63 may be implemented by a plurality of line buffer circuits. For instance, the buffer circuit 63 may include a left buffer circuit for buffer circuiting the post-processed left video image PLVI and a right buffer circuit for buffer circuiting the post-processed right video image PRVI.

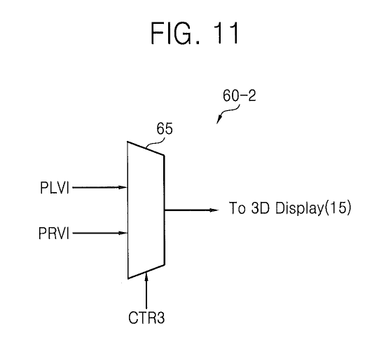

FIG. 11 is a block diagram of the 3D format generator circuit 60 illustrated in FIG. 2 according to other embodiments of the inventive subject matter. Referring to FIGS. 2 and 11, a 3D format generator circuit 60-2 includes only a selector circuit 65. The selector circuit 65 outputs either the post-processed left video image PLVI or the post-processed right video image PRVI in response to the third control signal CTR3.

Referring back to FIGS. 1 and 2, the 3D display engine 10 may also further include a frame buffer circuit 70. The frame buffer circuit 70 may store the decoded left video image DLVI and the decoded right video image DRVI. The frame buffer circuit 70 may also store the post-processed left video image PLVI and the post-processed right video image PRVI. According to some embodiments, the frame buffer circuit 70 may include a left frame buffer circuit storing the decoded or post-processed left video image DLVI or PLVI and a right frame buffer circuit storing the decoded or post-processed right video image DRVI or PRVI. The frame buffer circuit 70 receives the decoded left video image DLVI and the decoded right video image DRVI from the decoder 5 and stores them.

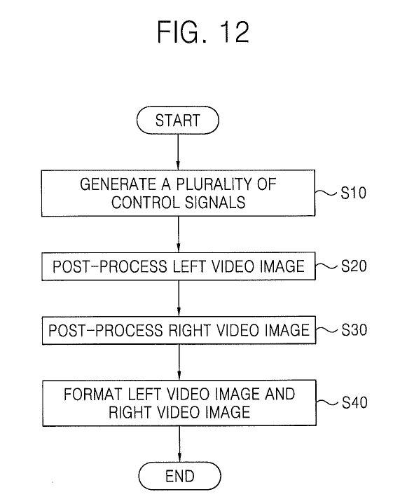

FIG. 12 is a flowchart illustrating operations of the 3D display engine 10 according to some embodiments of the inventive subject matter. Referring to FIGS. 2 and 12, the timing generator circuit 20 analyzes the format of the 3D display 15 and generates a plurality of timing control signals and the controller circuit 30 generates the plurality of the control signals CTR1, CTR2, and CTR3 based on the timing information of the plurality of timing control signals in operation S10. The format of the 3D display 15 is one of the formats illustrated in FIGS. 3 through 8.

The first post processor circuit 40 post-processes a left video image in response to the first control signal CTR1 in operation S20. The second post processor circuit 50 post-processes a right video image in response to the second control signal CTR2 in operation S30. The post-processing of the left video image in operation S20 and the post-processing of the right video image in operation S30 may be sequentially or simultaneously performed.

The 3D format generator circuit 60 performs frame packing of the post-processed left video image PLVI and the post-processed right video image PRVI according to one of the formats illustrated in FIGS. 3 through 8 in response to the third control signal CTR3. The 3D display 15 displays the post-processed left video image PLVI and the post-processed right video image PRVI in a single frame according to the packing in operation S40.

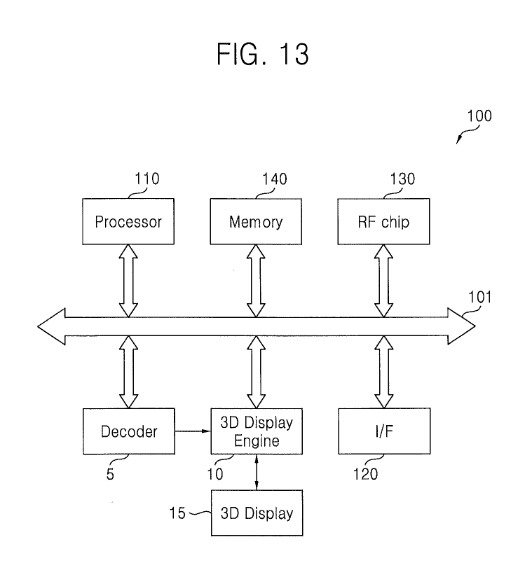

FIG. 13 is a schematic block diagram of a 3D display system 100 including the 3D display engine 10 according to other embodiments of the inventive subject matter. The 3D display system 100 may be implemented by a personal computer (PC), a portable computer, a handheld communication device, a smart phone, a digital television, a tablet PC, or a home automation system.

The 3D display system 100 includes the 3D display engine 10 and a processor circuit 110 which are connected to each other through a system bus 101. The 3D display engine 10 and the processor circuit 110 may perform data communication according to a communication protocol.

The 3D display system 100 may also include the decoder 5. The decoder 5 and the 3D display engine 10 may be implemented on a single chip. The processor circuit 110 may control the overall operation of the 3D display system 100, e.g., the operation of the 3D display engine 10.

The 3D display system 100 may also include an interface 120. The interface 120 may be an input/output interface. The input/output interface may be an output device such as a printer or an input device such as a mouse or a keyboard.

The 3D display system 100 may also include a radio frequency (RF) chip 130 capable of communication to receive an encoded video source. Video image output from the 3D display engine 10 may be controlled by the processor circuit 110 to be stored in a memory 140.

As described above, according to some embodiments of the inventive subject matter, a 3D display engine includes a post processor circuit for post-processing a left video source and a post processor circuit for post-processing a right video source separately, thereby not requiring high frequency and reducing the complexity. In addition, a post processor circuit used in a 2D display engine can be used as it is for a left video post processor circuit and a right video post processor circuit in the 3D display engine.

While the inventive subject matter has been particularly shown and described with reference to exemplary embodiments thereof, it will be understood by those of ordinary skill in the art that various changes in forms and details may be made therein without departing from the spirit and scope of the inventive subject matter as defined by the following claims.

What is claimed is:

1. A three-dimensional (3D) display engine comprising:
a timing generator circuit configured to generate a plurality of timing control signals according to a format of a 3D display;
a controller circuit configured to generate first, second and third control signals based on the plurality of timing control signals;
a first processor circuit configured to process left video image data in response to the first control signal;
a second processor circuit configured to process right video image data in response to the second control signal; and
a 3D format generator circuit configured to frame-pack the processed left and right video image data in the format of the 3D display in response to the third control signal.

2. The 3D display engine of claim 1, further comprising a frame buffer circuit configured to store the left video image data and the right video image data.

3. The 3D display engine of claim 1, wherein the first processor circuit comprises:
an image enhancer circuit configured to process the left image video data to reduce noise and/or blurring;
a scaler circuit configured to convert the left video image data from a first resolution to a second resolution;
a color space converter circuit configured to convert the left video image data from a first color space to a second color space; and
a layout overlay mixer circuit configured to generate overlaid left video image data.

4. The 3D display engine of claim 1, wherein the second processor circuit comprises:
an image enhancer circuit configured to process the right image video data to reduce noise and/or blurring;
a scaler circuit configured to convert the right video image data from a first resolution to a second resolution;
a color space converter circuit configured to convert the right video image data from a first color space to a second color space; and
a layout overlay mixer circuit configured to generate overlaid right video image data.

5. The 3D display engine of claim 1, wherein the 3D format generator circuit comprises:
a selector circuit configured to select the processed left or right video image data; and
a buffer circuit configured to store the selected left or right video image data.

6. The 3D display engine of claim 1, wherein the 3D format generator circuit comprises a selector circuit configured to selectively output the processed left and right video image data.

7. The 3D display engine of claim 1, wherein the timing generator circuit is configured to generate the plurality of timing control signals responsive to information transmitted by the 3D display.

8. The 3D display engine of claim 7, wherein the information transmitted by the 3D display identifies a resolution, a line frequency and/or a pixel frequency of the 3D display.

9. The 3D display engine of claim 7, wherein the timing generator circuit is configured to generate a vertical synchronization signal and/or a horizontal synchronization signal, and wherein the controller circuit is configured to generate the first, second and third control signals responsive to the vertical synchronization signal and/or the horizontal synchronization signal.

10. A 3D display system comprising the 3D display engine of claim 1 coupled to a 3D display.

11. A method comprising:
receiving format information from a 3D display;
generating first, second and third control signals responsive to the received format information;
processing left video image data in response to the first control signal;
processing right video image data in response to the second control signal; and
frame packing the processed left video image data and the processed right video image data in a format of the 3D display in response to the third control signal.

12. The method of claim 11, wherein generating first, second and third control signals comprises:
generating a plurality of timing control signals responsive to the received format information; and
generating the first, second and third control signals based on the plurality of timing control signals.

13. The method of claim 11, wherein processing left video image data comprises:
processing the left video image data to reduce noise and/or blurring;
converting the left video image data from a first resolution to a second resolution;
converting the left video image data from a first color space to a second color space; and
mixing on the left video image data to generate an overlaid left video image stream.

14. The method of claim 11, wherein processing the right video image data comprises:
processing the right video image data to reduce noise and/or blurring;
converting the right video image data from a first resolution to a second resolution;
converting the right video image data from a first color space to a second color space; and
mixing on the right video image data to generate an overlaid right video image stream.

15. The method of claim 11, wherein frame packing the processed left video image data and the processed right video image data comprises:
selecting the processed left and right video image data; and
buffer circuiting the selected processed left and right video image data.

16. The method of claim 11, wherein frame packing the processed left video image data and the processed right video image data comprises selectively outputting the processed left and right video image data.

17. A 3D display engine comprising:
a timing generator circuit configured to receive format information from a 3D display and to responsively generate display timing information;
a video image data processor circuit configured to receive and process left and right video image data;
a 3D format generator circuit configured to frame-pack the processed left and right video image data; and
a controller circuit configured to control the video image data processor circuit and the 3D format generator circuit responsive to the display timing information.

18. The 3D display engine of claim 17:
wherein the video image data processor circuit comprises:
a first processor circuit configured to process left video image data in response to a first control signal; and
a second processor circuit configured to process right video image data in response to a second control signal;
wherein the 3D format generator circuit is configured to frame-pack the processed left and right video image data in response to a third control signal; and
wherein the controller circuit is configured to generate the first, second and third control signals.

19. The 3D display engine of claim 17, wherein the display timing information pertains to a vertical synchronization, a horizontal synchronization, a line frequency and/or a pixel frequency.
